(19) United States
(12) Patent Application Publication
(10) Pub. No.: US 2010/0121912 A1
(43) Pub. Date: May 13, 2010

(54) TERMINAL DEVICE, COMMENT DISTRIBUTION SERVER, COMMENT TRANSMISSION METHOD, COMMENT DISTRIBUTION METHOD, AND RECORDING MEDIUM THAT HOUSES COMMENT DISTRIBUTION PROGRAM

(75) Inventors: Nobuo Kawakami, Tokyo (JP); Akihiko Koizuka, Koshigaya-shi (JP)

Correspondence Address: CANTOR COLBURN, LLP, 20 Church Street, 22nd Floor, Hartford, CT, 06103, US

(73) Assignee: DWANGO CO., LTD., Tokyo (JP)

(21) Appl. No.: 12/596,104

(22) PCT Filed: Apr. 23, 2008
(86) PCT No.: PCT/JP2008/057861

§ 371 Date: Oct. 15, 2009

(30) Foreign Application Priority Data
Apr. 27, 2007 (JP) 2007-120322

(51) Int. Cl. G06F 15/16

(52) U.S. Cl. 709/203

(57) ABSTRACT

The terminal device of the present invention has a list storage portion that stores content identification information that identifies content that can be uttered as a comment on moving image data as a list, an input portion that receives a data input of a selection instruction that selects a content as a comment from a user, and a transmission portion that receives an input of content identification information of a content that is selected from the list storage portion in accordance with the selection instruction that is input to the input portion for moving image data that is distributed from the moving image distribution server and transmits a moving image playback elapsed time at the point of time that the content identification information is imparted as a comment as a comment imparting time together ether with the content identification information as comment information.

### TECHNICAL FIELD

The present invention relates to a terminal device that collects comments uttered from a user and distributes the collected comments in accordance with the content, a comment distribution server, a comment transmission method, a comment distribution method, and a recording medium that houses a comment distribution program.

Priority is claimed on Japanese Patent Application Publication No. 2007-120322, filed Apr. 27, 2007, the content of which is incorporated herein by reference.

### BACKGROUND ART

Conventionally, there is a system that displays comments uttered by a user with respect to the content of a moving image, such as a television program that has been broadcasted, together with that moving image.

For example, in a bulletin board that relates to a television program or the like, by writing comments on a scene of the television program from each the users' terminals, it is possible to utter various comments by sharing the same television program among users. This kind of system is proposed for example as Patent Document 1. The utterances of these comments can be freely made if a user.

[Patent Document 1] Japanese Unexamined Patent Application Publication No. 2002-290949

### DETAILED DESCRIPTION OF THE INVENTION

### Problems to be Solved by the Invention

However, in the system in the abovementioned prior art, although users can freely make utterances, the ability itself is limited to an extent of being able to input text information. In this way, no matter how much the input of text information has been possible, there has been a demand from users who utilize this input function of text information of wanting to register audio and images other than text information as comments, and it has been desired to have these demands met.

The present invention was achieved in view of the above circumstances, and has as its object to provide a terminal device that is capable of making utterances even if it is information other than text, a comment distribution server, a comment transmission method, a comment distribution method, and a program.

### Means for Solving the Problem

In order to solve the aforementioned problems, the present inventors achieved the following invention.

(1) A terminal device in a comment distribution system that has a moving image distribution server that distributes moving image data, a comment distribution server that distributes comments on a moving image, and a terminal device, having a list storage portion that stores content that can be uttered as a comment on the moving image data as a list of content identification information that identifies the content; an input portion that receives a data input of a selection instruction that selects a content to be uttered as a comment from a user on a content that is stored in the list storage portion; and a transmission portion that receives an input of content identification information of a content that is selected from the list storage portion in accordance with the selection instruction input to the input portion for moving image data that is distributed from the moving image distribution server and transmits a moving image playback elapsed time at the point of time that the content has been uttered as a comment as a comment imparting time together with the content identification information as comment information to the comment distribution server.

(2) The terminal device according to (1), in which the content is any one of text, audio, a still image, a moving image, or a program.

(3) The terminal device according to (1) or (2), having a content storage portion that stores content identification information and content that becomes the substance of the comment in a corresponding manner; a comment information receiving portion that receives comment information that is distributed from the comment distribution server; a content reading portion that, among the comment information that the comment information receiving portion has received, reads the content identification information of the comment information in which a comment imparting time that corresponds to the playback elapsed time of the moving image data is set, and reads from the content storage portion the content that corresponds to the content identification information that was read; and a content output portion that, in accordance with the comment imparting time, outputs the content that the content reading portion has read in accordance with the playback elapsed time of the moving image data.

(4) The terminal device according to any one of (1) through (3), in which a content distribution server that distributes a content to become a comment that can be uttered on the moving image data is provided in the comment distribution system; and the content reading portion, in the case of the content corresponding to the content identification information not being stored in the content storage portion, downloads the content corresponding to the content identification information from the content distribution server.

(5) The terminal device according to any one of (1) through (4), in which the output portion, in the case of downloading of the content corresponding to the content identification information not being completed at the playback elapsed time that corresponds to the comment imparting time of the moving image data, outputs a content that is different from the content whose downloading is not completed.

(6) The terminal device according to any one of (1) through (5), in which the list storage portion stores a possible number of times of utterance of being possible of uttering a content as a comment, and each time a content that is stored in the list storage portion is selected by the input portion, decreases the count number of the possible number of times of utterance, and in the case of having a possible number of times of utterance, can be made utterable.

(7) The terminal device according to any one of (1) through (6), in which the list storage portion stores a possible period of utterance of being possible of uttering a content as a comment, and in the case of a content that is stored in the list storage portion being selected by the input portion, in the case of the content being in the possible period of utterance, can be made utterable.

(8) A comment distribution server in a comment distribution system that has a moving image distribution server that distributes moving image data, a comment distribution server that distributes comments on a moving image, and a terminal device, having a user information storage portion that stores content identification information that identifies content that is capable of being uttered as a comment on the moving image in correspondence with user identification information that identifies users; a receiving portion that receives as comment information content identification information, user identification information, and a comment imparting time that shows the moving image playback elapsed time at the point of time that the content identification information was imparted as a comment, that are transmitted from the terminal device; an authentication portion that refers to the user information storage portion and detects whether or not the combination of the content identification information and the user identification information that the receiving portion has received has been stored in the user information storage portion; a comment information storage portion that stores comment information; a comment information management portion that, based on the authentication result of the authentication portion, in the case of the combination of the content identification information and the user identification information that the receiving portion has received being stored in the user information storage portion, stores the comment information in the comment information storage portion, and in the case of the combination of the content identification information and the user identification information that the receiving portion has received not being stored in the user information storage portion, does not store the comment information in the comment information storage portion, and a comment information distribution portion that distributes comment information that is stored in the comment information storage portion to the terminal device.

(9) The comment distribution server according to (8), in which the receiving portion receives comment information from the terminal device according to any one of (1) through (7).

(10) A comment transmission method of a terminal device in a comment distribution system that has a moving image distribution server that distributes moving image data, a comment distribution server that distributes comments on a moving image, and a terminal device, including the steps of receiving data input of a selection instruction that selects a content to be uttered as a comment from a user on a content that is stored in a list storage portion that stores content that can be uttered as a comment on the moving image as a list of content identification information that identifies the content concerned; and receiving an input of content identification information of a content that has been selected from the list storage portion in accordance with the selection instruction that is data input on moving image data that is distributed from the moving image distribution server, and transmitting to the comment distribution server the moving image playback elapsed time at the point in time of the content being uttered as a comment as a comment imparting time along with the content identification information as comment information.

(11) A comment distribution method in a comment distribution server in a comment distribution system that has a moving image distribution server that distributes moving image data, a comment distribution server that distributes comments on a moving image, and a terminal device, including the steps of receiving as comment information content identification information, user identification information, and a comment imparting time that shows the moving image playback elapsed time at the point of time that the content identification information was imparted as a comment, that are transmitted from the terminal device; referring to a user information storage portion that stores content identification information that identifies content that is capable of being uttered as a comment on the moving image data in correspondence with the user identification information that identifies users, and detecting whether or not the combination of the content identification information and the user identification information that have been received has been stored in the user information storage portion, based on the authentication result of the authentication portion, in the case of the combination of the content identification information and the user identification information that have been received being stored in the user information storage portion, storing the comment information in a comment information storage portion that stores comment information, and in the case of the combination of the content identification information and the user identification information that have been received not being stored in the user information storage portion, not storing the comment information in the comment information storage portion, and distributing the comment information that has been stored in the comment information storage portion to the terminal device.

(12) A computer-readable recording medium that houses a program that, in a computer of a terminal device in a comment distribution system that has a moving image distribution server that distributes moving image data, a comment distribution server that distributes comments on a moving image, and a terminal device, performs a function that receives data input of a selection instruction that selects a content to be uttered as a comment from a user on a content that is stored in the list storage portion that stores content that can be uttered as a comment on the moving image data as a list of content identification information that identifies the content; and a function that receives an input of content identification information of a content that has been selected from the list storage portion in accordance with the selection instruction that is data input on moving image data that is distributed from the moving image distribution server, and transmits to the comment distribution server the moving image playback elapsed time at the point in time of the content being uttered as a comment as a comment imparting time along with content identification information as comment information.

(13) A computer-readable recording medium that houses a program that, in a computer of a terminal device in a comment distribution system that has a moving image distribution server that distributes moving image data, a comment distribution server that distributes comments on a moving image, and a terminal device, performs a function that that receives as comment information content identification information, user identification information, and a comment imparting time that shows the moving image playback elapsed time at the point of time that the content identification information was imparted as a comment, that are transmitted from the terminal device; a function that refers to a user information storage portion that stores content identification information that identifies content that is capable of being uttered as a comment on the moving image data in correspondence with user identification information that identifies users, and detects whether or not the combination of the content identification information and the user identification information that have been received has been stored in the user information storage portion; and a function that, based on the detection result, in the case of the combination of the content identification information and the user identification information that have been received being stored in the user information storage portion, stores the comment information in the comment information storage portion, and in the case of the combination of the content identification information and the user identification information that have been received not being stored in the user information storage portion, does not store the comment information in the comment information storage portion.

### EFFECT OF THE INVENTION

As described above, according to this invention, since a user who has the authorization to use a content is able to utter that content as a comment, it is possible to register even information other than text as a comment. Thereby, a user is able to perform an utterance with information other than text, and so it is possible to further enhance the communication property and the entertainment property.

### BRIEF DESCRIPTION OF THE DRAWINGS

FIG. 1 is a conceptual drawing showing the composition of the comment distribution system in accordance with one embodiment of this invention.

FIG. 2 is an outline block diagram showing the composition of the comment distribution server 2.

FIG. 3 is a drawing that shows an example of data that is stored in the comment information storage portion 27.

FIG. 4 is a drawing that shows an example of the information that is stored in the user information storage portion 22.

FIG. 5 is an outline block diagram for describing the composition of the terminal device 3.

FIG. 6 is a drawing that shows an example of the information displayed on the output device 314.

FIG. 7 is a flowchart for describing the operation of the comment distribution server 2.

FIG. 8 is a flowchart for describing the operation of the terminal device 3.

FIG. 9 is a flowchart for describing the operation of the terminal device 3.

FIG. 10 is a drawing that shows an example of the screen that selects the content that can be uttered as a comment.

### REFERENCE NUMERALS

1 moving image distribution server, 2 comment distribution server, 3 terminal device, 5 content distribution server, 21 communication portion, 22 user information storage portion, 23 content purchase information receiving portion, 24 authentication portion, 25 comment information management portion, 26 comment information distribution portion, 27, 313 comment information storage portion, 311 moving image playback portion, 312 receiving portion, 314 output device, 315 first output portion, 316 second output portion, 317 input portion, 318 selection portion, 319 playback control portion, 320 list storage portion, 321 download portion, 322 content storage portion, 323 transmission portion

### BEST MODE FOR CARRYING OUT THE INVENTION

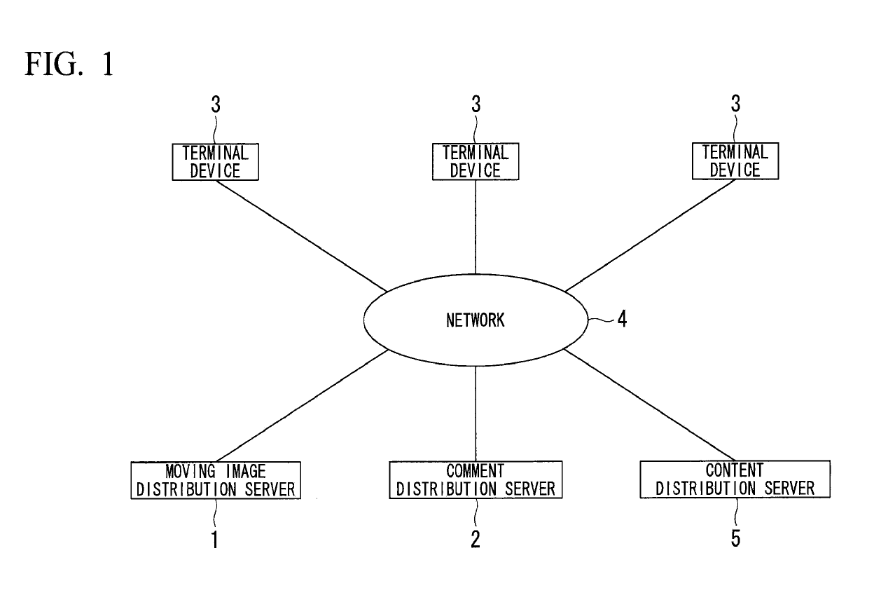

Herinbelow, a comment distribution system in accordance with one embodiment of the present invention shall be described with reference to the drawings. FIG. 1 is a conceptual drawing showing the composition of the comment distribution system in accordance with one embodiment of this invention. In this drawing, in the comment distribution system, a moving image distribution server 1, a comment distribution server 2, terminal devices 3, and a content distribution server 5 are connected via a network 4. The moving image distribution server 1 distributes moving image data in accordance with distribution requests from the terminal device 3. This distribution is performed by streaming, for example. The comment distribution server 2 receives from the terminal device 3 a comment corresponding to the moving image that the moving image distribution server 1 distributes and distributes the received comment to the terminal devices 3 that are viewing that moving image.

The terminal device 3 is capable of being connected to the moving image distribution server 1, the comment distribution server 2, and the content distribution server 5 via the network 4, and in addition to receiving and displaying a moving image that is distributed from the moving image distribution server 1, receives comments distributed from the comment distribution server 2, and when the received comments are text, outputs them onto the moving image displayed on a display device.

Moreover, when a received comment consists of content, the terminal device 3 downloads the content from the content distribution server 5, stores it in the terminal device 3, and outputs this content. As for this output, in the case of the content being an image, it is displayed on the display device, and in the case of the content being audio, it is output from an audio output device. Here, audio content includes for example songs and sound effects.

As this terminal device 3, it may be one that has a function to display a moving image and output audio, and for example a PC, mobile phone, PDA, handheld game unit and the like are applicable.

The content distribution server 5 distributes the content that can be uttered as a comment on moving image data. This content includes a moving image, a still image, a photograph, an illustration, animation, a song, a sound effect, and a program.

Next, the comment distribution server 2 and the terminal device 3 in FIG. 1 shall be further described with drawings.

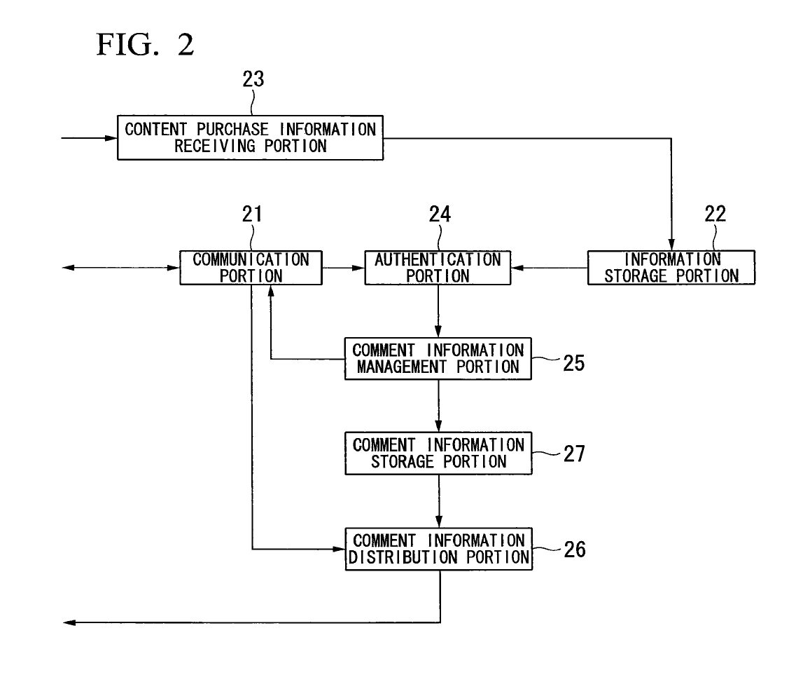

FIG. 2 is an outline block diagram showing the composition of the comment distribution server 2. In this drawing, a comment information storage portion 27 stores information related to imparted (uttered) comments as comment information.

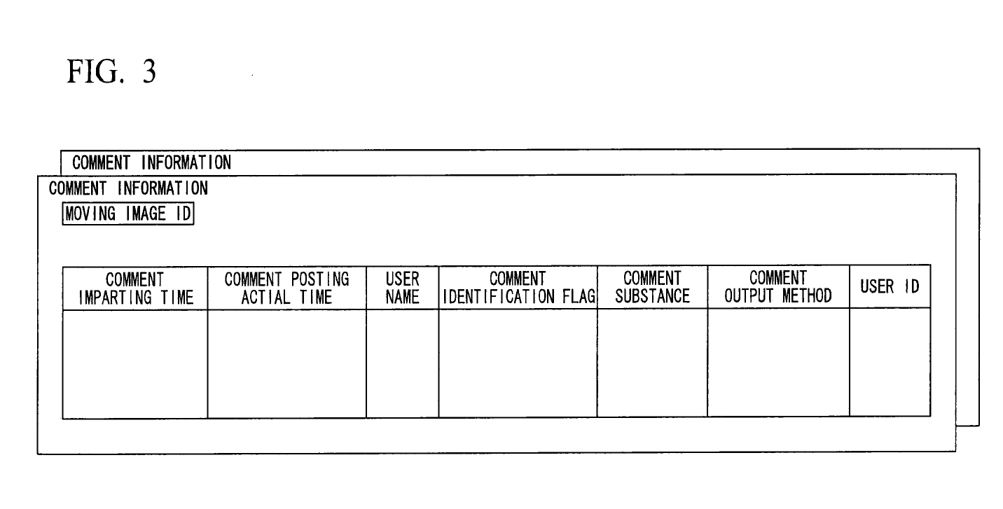

An example of the information stored by this comment information storage portion 27 is shown in FIG. 3. A plurality of comment information that consist of comments on a moving image distributed by the moving image distribution server 1 summarized into threads are stored in the comment information storage portion 27. Each comment information includes moving image ID information that identifies a moving image, so as to be capable of identifying which moving image the thread belongs to. Comment information contains at least one comment data. This comment data includes, in addition to the comment imparting time and the comment substance, the comment posting actual time that shows the actual time of imparting (making) that comment, the user name that is the name of the user that imparted the comment, a comment identification flag for identifying whether the comment substance is text or whether it is content, a comment output method that is information that specifies how the comment should be output onto the screen of the terminal device or to an audio output device, and a user ID (corresponding to user identification information) that is information that identifies the user that imparted the comment.

Also, in the case of receiving comment data from the terminal device 3 that is playing back the moving image of a certain moving image ID and viewing comments of that moving image ID, the relevant comment data is additionally saved in the comment information. In the present embodiment, the comment posting actual time is not included in the comment data that is transmitted from the terminal device 3, and rather the time at which the comment distribution server 2 has received the comment data serves as the comment posting actual time, and in addition is additionally saved in the comment information, but the time at which the comment was imparted (uttered) in the terminal device 3 may serve as the comment posting actual time, and the comment data that includes this may be transmitted to the comment distribution server 2.

The user name is the name that is capable of being displayed on a screen as the person who uttered the comment, and for example may be set by the user himself who utters comments.

The comment identification flag, in the case of being “0” for example, shows that the comment substance is text, and in the case of being “1”, shows that the comment substance is content.

As for the comment substance, in the case of a comment being text, that text data is housed. In the case of a comment being content, the content name, which is the name of the content to be displayed in a content list, and content identification information are included as the comment substance. In the case of the content identification information being a character string of, for example, 8 alphanumeric symbols, a portion of that character string may be used for identifying whether or not the content is a moving image, audio, a program, or the like.

As for the comment output method, in the case of the comment being content, and that content being a moving image, the size of the moving image, the display position, the movement direction, the movement speed, and the like, can be set, and in the case of the content being audio, it is possible to set the volume and the time of being emitted, and the like.

Returning to FIG. 2, the communication portion 21 receives the comment imparting time that shows the moving image playback time at the point in time of a comment being imparted, the user name, the comment identification flag, the comment substance, the comment output method, and the user ID that are transmitted from the terminal device 3.

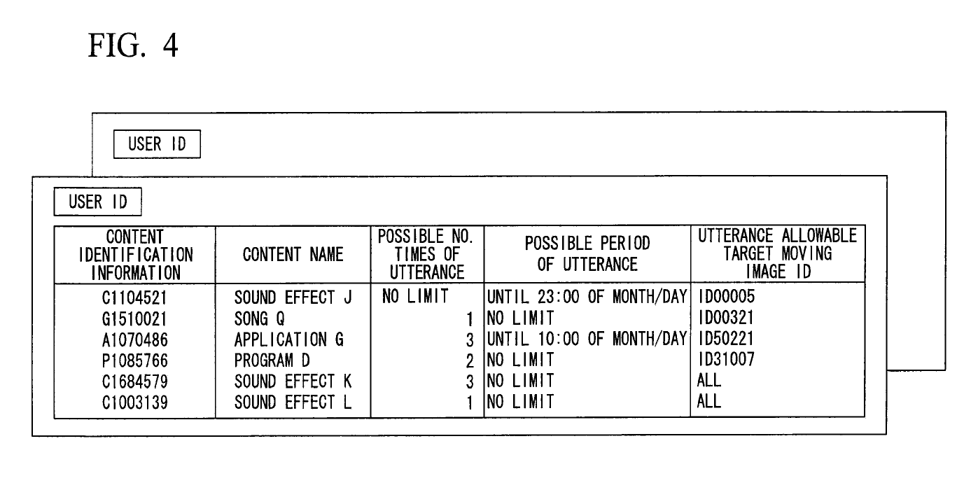

The user information storage portion 22 stores the content identification information that a user specified by the user ID is capable of uttering as a comment for every user ID. Also, in the case of content in which there is a limit on the moving images on which it can be uttered, and the possible number of times of utterance and the possible period of utterance, information relating thereto, and the content name are included. FIG. 4 shows an example of the information that is stored in the user information storage portion 22.

The content that can be uttered is that which a user has purchased in advance with a payment or without payment. The purchasing of this content may be such that a fee is collected on a per item basis, or collected over a certain period (for example, one month), during which content of a determined number may be purchased. Also, purchases may be made by exchanging with points that are obtained when purchasing goods or services. The purchase of this content is performed by for example making a connection from the terminal device 3 to the content distribution server 5, downloading the content from the content distribution server 5, and a fee being collected in accordance with this download.

When the terminal device 3 connects to the content distribution server 5, and has purchased content, the content purchase information receiving portion 23 receives content purchase information that has been notified from the content distribution server 5. The user ID of the user that has purchased this content, the content identification information of the purchased content, and the purchased number are included in this content purchase information.

An authentication portion 24 refers to the user information storage portion 22 and detects whether or not the combination of the content identification information and user ID that the communication portion 21 has received is stored in the user information storage portion 22 and whether or not it is possible to utter the content as a comment, and then outputs the detection result to the comment information management portion 25. Here, being able to utter a content as a comment means that an utterance can be made on the moving image that is the target, that there is a remainder in the possible number of times of utterance (including those in which there is no limit on the possible number of times of utterance), and that it is within the possible period of utterance (including those in which the utterance period is indefinite).

Also, in the case of being content in which there is a limit on the possible number of times of utterance, each time an utterance that uses this content is performed, the possible number of times of utterance decreases by 1, and when the possible number of times of utterance becomes 0, the content identification information of the content concerned is deleted from the list of content identification information that corresponds to the user ID.

Also, in the case of content in which there is a limit on the period uttering the content, in the case of the period concerned having already passed, the content identification information of the content concerned is deleted from the list of content identification information that corresponds to the user ID.

Based on the authentication result of the authentication portion 24, in the case of the combination of the content identification information and the user ID that the communication portion 21 has received being stored in the user information storage portion 22 and the content capable of being uttered, the comment information management portion 25 stores the comment information in the comment information storage portion 27, and if the case of not being so, discards the comment information without storing it in the comment information storage portion 27.

The comment information distribution portion 26 distributes the comment information that is stored in the comment information storage portion 27 to the terminal device 3 according to the directions from the communication portion 21.

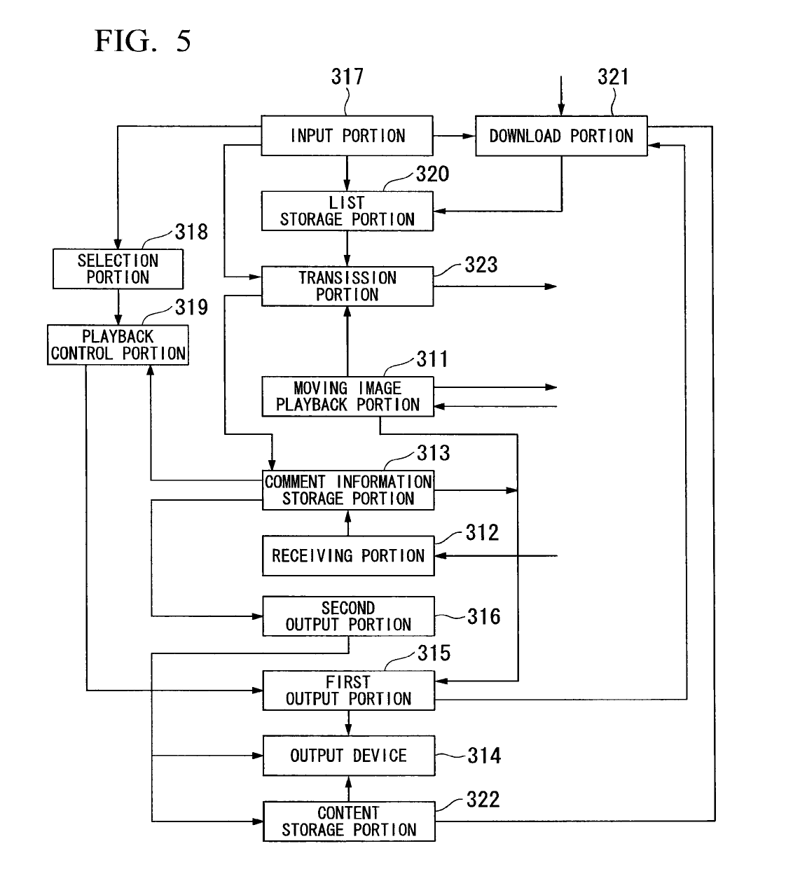

Next, the terminal device 3 shall be described using a drawing. FIG. 5 is an outline block diagram for describing the composition of the terminal device 3.

In this drawing, a moving image playback portion 311 transmits a distribution request of a moving image specified by the user of the terminal device 3 to the moving image distribution server 1, receives the moving image distributed from the moving image distribution server 1, and plays it. The receiving portion 312 receives the comment information that is input with respect to the moving image being played back from the comment distribution server 2. A comment information storage portion 313 stores the comment information that the receiving portion 312 has received.

An output device 314 is a liquid crystal display, a CRT (Cathode Ray Tube), or an audio output device such as a speaker, and outputs a variety of information by these.

A first output portion 315 acquires the moving image replay elapsed time of the moving image that is being played back from the moving image playback portion 311, reads the comment data in which the comment imparting time corresponds to the acquired moving image replay elapsed time of the moving image among the comment information that is stored in the comment information storage portion 313, and outputs the comments of the comment data that was read by the output device 314.

Also, in the case of content that corresponds to the content identification information that is included in the comment data that is stored in the content information storage portion 313 not being stored in a content storage portion 322 described below, the first output portion 315 downloads the content that corresponds to the content identification information concerned from the content distribution server 5 by the download portion 321.

Also, in the case of the downloading of the content that corresponds to the comment imparting time concerned not being completed at the playback time that corresponds to the comment imparting time of the moving image data, the first output portion 315 outputs a content that differs from the content being downloaded as a substitute content.

This substituted content may be decided in advance, or may be selected at random from pre-registered content and output.

A second output portion 316 displays a list of comments on the display screen of the output device 314 as a comment list based on the comment data stored in the comment information storage portion 313. Here, it is displayed in accordance with the order of the comment posting actual time information contained in the comment data.

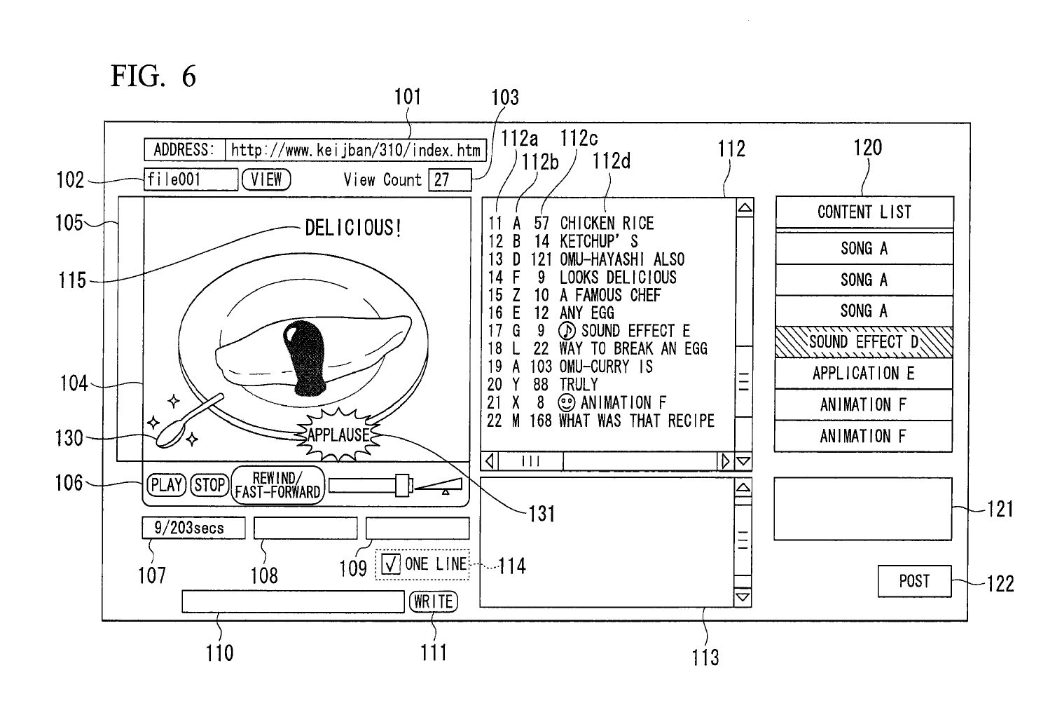

The information displayed on this output device 314 shall be explained further. FIG. 6 is a drawing that shows an example of the information displayed on the output device 314. The URL (uniform resource locator) at the time of accessing this comment distribution server 2 is displayed in a display bar 101. The moving image ID of the moving image that is being played back is displayed in a display field 102. The total number of times that the moving image that is presently displayed has been requested for viewing is displayed in the display column 103 as a view count. As for this view count, in the case of another user playing (making a request for viewing) the moving image, the counted number of users during viewing of the same moving image at that time is increased, and the count number is updated as displayed. The moving image displayed by the first output portion is displayed in the display space 104. The display space 105 is a region where the comments of the comment list displayed by the second output portion are sequentially displayed according to the comment imparting time, and here comments are displayed on the moving image that is displayed by the display space 104. Moreover, here the display space 105 is set as a larger size than the display space 104, and comments or the like that are overlaid are trimmed on the outer side of the screen of the moving image so that the comments themselves are not included in the moving image, and so it becomes possible to grasp that they have been written by users on the moving image.

An operation panel 106 has a play button, a stop button, a rewind button, a fast forward button, a volume adjustment button, and a playback state display column that shows which part of the entire moving image is being played, and so by using the mouse to position the cursor on any button and clicking it, the input of the operation corresponding to that button is received. In a display column 107, the playback time length of the entire moving image and the moving image playback elapsed time of the moving image that is currently being displayed in the display space 104 are displayed. In the input field 108, the user name that is making an utterance on the moving image is input via an input portion 317. Here, a check box is provided near the input field 108, and depending on whether or not this check box has been checked selects whether or not a mail address is input, and in the case of this check box being checked, the input field 108 is divided into two, and the input of the user name and the mail address of the user may be accepted. Information of the comment output method that designates the method of outputting a text comment to be input into the input field 110 is input into the input field 109. As a way of outputting according to the comment output method, for example, the position at which the text comment is displayed on the moving image, font, character size, starting position and ending position of a moving display, and the direction of the moving display may be selectively set as information that give directions for causing an overlay display. Note that as for this comment output method, it is possible for it to be decided in advance so that the user need not input it.

A comment consisting of text is input into the input field 110 by the user via the input portion 317. When the button 111 is clicked, a comment consisting of text that has been input into the input field 110, the user name that has been input into the input field 108, the comment output method that has been input in the input field 109, the comment identification flag of the content that shows that the comment is text, the comment imparting time, the moving image ID, and the user ID are transmitted to the comment distribution server 2. The display space 112 is a region where the comment list, which is a list of comments, is displayed. A number (reference numeral 112a) that shows the utterance order imparted to a comment, the name of the user that has input the comment (reference numeral 112b), the comment imparting time at which the comment was written (reference numeral 112c), and a portion of the comment that was uttered (reference numeral 112d), are displayed in this comment list in accordance with the posted actual time information. In the vicinity of this display space 112, an input column such as a check box is provided to designate whether or not to display the display space 112 on the screen, and in accordance with the display designation that is input in this input column, it is possible to cause the display space 112 to either be displayed or to hide the display. Also, it is possible to change the number of pieces of comments displayed in this display space 112 in accordance with the user designation. Among the portions of comments that are displayed in this display space 112 (reference numeral 112d), in the case of the comment being content, a mark that shows that it is content and the content name are displayed. By this mark being displayed, it is possible to grasp whether text is displayed or whether content is being output. As for this mark itself, a different mark may be displayed depending on a classification such as whether the content is a moving image, audio, and the like.

In the comment list that is displayed in the display space 112, details of the comment over which the user has moved the cursor are displayed in the display column 113. As details of the comment, the entire sentence of the comment, the name of the user who uttered the comment, the mail address, and the like are displayed.

Inputting a check mark in the check box 114 specifies a comment that is input in the input field 110 as one line. For example, by inputting a check mark in the check box 114, when the input of the comment is finished, and for example the enter key or the like is pressed to input the input completion instruction, at the point that the enter key is pressed, it is treated as the “write” button being clicked, and the comment or the like is transmitted to the comment distribution server 2. Thereby, it is possible to input comments quickly and easily.

The display column 120 is a region where a list of the contents which a user can utter as a comment is displayed as a content list.

The information of the comment output method that specifies the output method of the content that has been selected from the content list of the display column 120 is input in the input space 121. For example, in the case of the content being a moving image, the input of the moving image size, the display position, the movement direction, and the movement speed and the like is possible, and in the case of the content being audio, input of the volume, the time of being emitted and the like is possible. Note that as for this comment output method, it is possible for it to be decided in advance so that the user need not input it.

By clicking the button 122, the content identification information of the content that has been selected in the input column 120, the user name that has been input in the input field 108, the comment output method that has been input in the input space 121, the content identification flag of the content that shows that the comment is content, the comment imparting time, the moving image ID, and the user ID are transmitted to the comment distribution server 2.

Next, returning to FIG. 5, the input portion 317 is an input device such as a mouse or keyboard, and accepts the input of various information from the user. In the case of the terminal device 3 being a portable electronic device, a ten-key pad or input button functions as the input portion 317. This input portion 317 has a function that receives the data input of the selection instruction that selects a content to be uttered as a comment from the user on a content that is stored in a list storage portion 320 described below. A selection portion 318 receives the input of a selection of a comment that is input via the input portion 317, among the comment list that is displayed by the second output portion 316. A playback control portion 319 reads from a comment information storage portion 313 comment data of the comment that is selected by the section portion 318, and causes a moving image to be played by the moving image playback portion 311 from the moving image playback elapsed time that corresponds to the comment imparting time of the comment data that was read.

The list storage portion 320 associates the content identification information that identifies content that can be uttered as a comment on the moving image data, the content name, the possible number of times of utterance of the content concerned, the possible period of utterance, and an utterance allowable target moving image ID that specifies the moving image serving as the target allowing utterance of this content, and stores them as a list.

The download portion 321 downloads the content from the content distribution server 5 and stores it in the content storage portion 322.

In the case of a content that is registered as a list being selected as a comment and the “post” button being clicked, the transmission portion 323 transmits the content identification information of the content that has been selected to the comment distribution server 2 as comment data.

Specifically, in the case that content that has been registered as a list being selected as a comment, a transmission portion 323 receives the input of content identification information of a content that has been selected from within the list storage portion 320 in accordance with the selection instruction input from the input portion 317 for moving image data that is distributed from the moving image distribution server 1, and the moving image playback elapsed time at the point of time that the content identification information concerned has been imparted as a comment is transmitted as the comment imparting time to the comment distribution server 2 along with the content identification information, the user name, the comment output method, the comment identification flag for identifying whether the comment is text or content, the moving image ID, and the user ID.

Also, in the case of the data such as text that is input from the input portion 317 being directly input as a comment, the transmission portion 323 accepts from the input portion 317 the data input of the comment substance on the moving image that is played by the moving image playback portion 311, and transmits the moving image playback elapsed time at the point of time that the comment substance has been input as the comment imparting time to the comment distribution server 2 along with the user name, the comment output method, the comment identification flag for identifying that the comment is text, the moving image ID, and the user ID.

Also, in accordance with the instruction that has been input from the input portion 317, the transmission portion 323 has a function that transmits various information and requests to the moving image distribution server 1, the comment distribution server 2 and the content distribution server 5.

Next, the operation of the aforementioned comment distribution system shall be described. Here, operation of the comment distribution server 2 and the terminal device 3 is explained in turn. Here, the operation of the terminal device 3 accessing the comment distribution server 2, inputting a user ID and password to login, receiving the content list corresponding to that user ID that is stored in the user information storage portion 22 from the comment distribution server 2 to the terminal device 3 and storing in the list storage portion 320 shall be described.

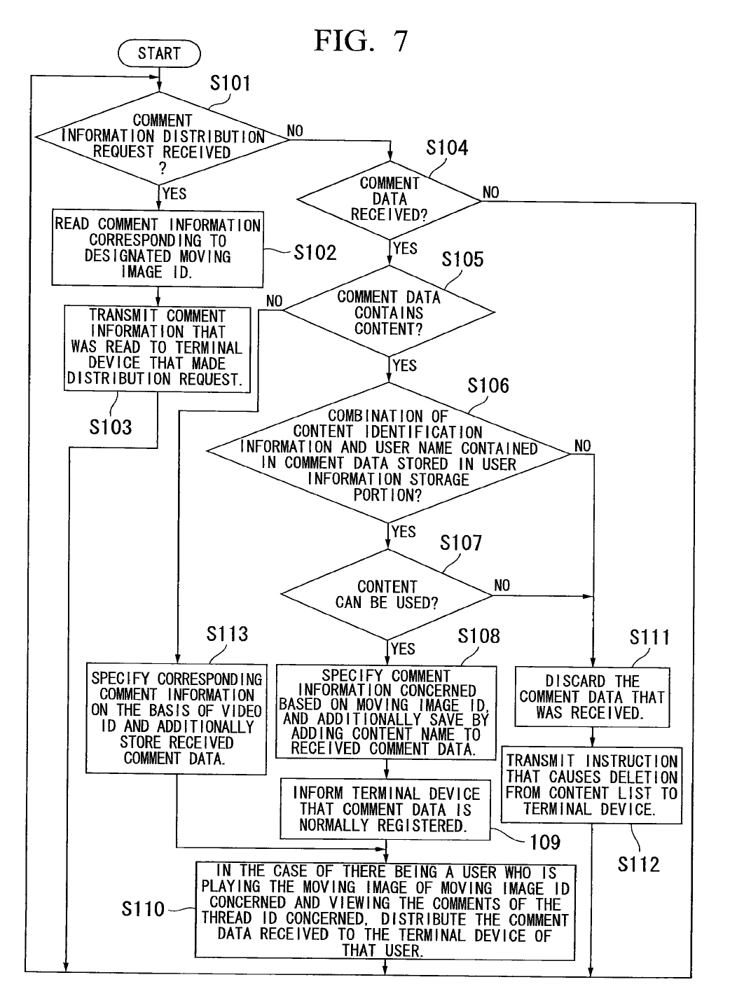

First, the operation of the comment distribution server 2 shall be described using the flowchart of FIG. 7.

The communication portion 21 of the comment distribution server 2 detects whether or not the distribution request of comment information was received from the terminal device 3 (Step S101).

In the case of a distribution request for comment information having been received (“YES” in Step S101), the communication portion 21 outputs the moving image ID contained in the distribution request to the comment information distribution portion 26. The comment information distribution portion 26 reads the comment information corresponding to the moving image ID from the comment information storage portion 27 (Step S102), and transmits the read comment information to the terminal device 3 that has made the distribution request (Step S103). Here, the comment data contained in the comment information that corresponds to the moving image ID is transmitted collectively.

Meanwhile, in Step S101, in the case of a distribution request for comment information not being received (“NO” in Step S101), the communication portion 21 judges whether or not the comment data that was transmitted from the terminal device 3 was received (Step S104). In the case of the comment data not having been received from the terminal device 3 according to the judgment of the communication portion 21 (“NO” in Step S104), the processing moves to Step S101, and in the case of the comment data having been received from the terminal device 3 (“YES” in Step S104), the authentication portion 24 judges whether or not the comment data contains content (Step S105), and in the case of not containing content (“NO” in Step S105), the comment information management portion 25 specifies the comment information concerned based on the moving image ID that is included in the received comment data, and additionally saves the received comment data to the comment information storage portion 27 (Step S113). Then, the processing proceeds to Step S110. On the other hand, in the case of containing content (“YES” in Step S105), it detects whether or not the combination of the content identification information and user ID included in the comment data is stored in the user information storage portion 22 (that is, whether or not the there is a content purchase history) (Step S106). In the case of the combination of the content identification information and user ID being stored in the user information storage portion 22 (“YES” in Step S106), the authentication portion 24 judges whether or not the content can be used (Step S107). The judgment of whether or not this content can be used, for example, in the case of a possible period of utterance has been set in the content, is performed by judging whether or not the present time at the time of having received the comment data is within the possible period of utterance. When it is judged that the content can be used (“YES” in Step S107), the comment information management portion 25 specifies the comment information concerned based on the moving image ID that is included in the received comment data, and additionally saves it to the comment information storage portion 27 by adding the content name to the received comment data (Step S108).

When the comment data is additionally saved, the communication portion 21 informs the terminal device 3 that transmitted the comment data that the comment data has been normally registered (Step S109). When this notification is performed, the comment information distribution portion 26 distributes the comment data concerned that was additionally saved to the terminal device 3 which is viewing the comments of the comment information that was additionally saved (Step S110). Here, it is also transmitted to the terminal device 3 that transmitted the comment data.

In the Step S106, when the combination of the content identification information and user ID has not been stored in the user information storage portion 22 (“NO” in Step S106), or when it is judged that the content is not usable in Step S107 (“NO” in Step S107), the comment information management portion 25 discards the comment data that was received (Step S111). When the comment data is discarded, the communication portion 21 transmits an instruction in order to delete the comment concerned from the content list to the terminal device 3 (Step S112).

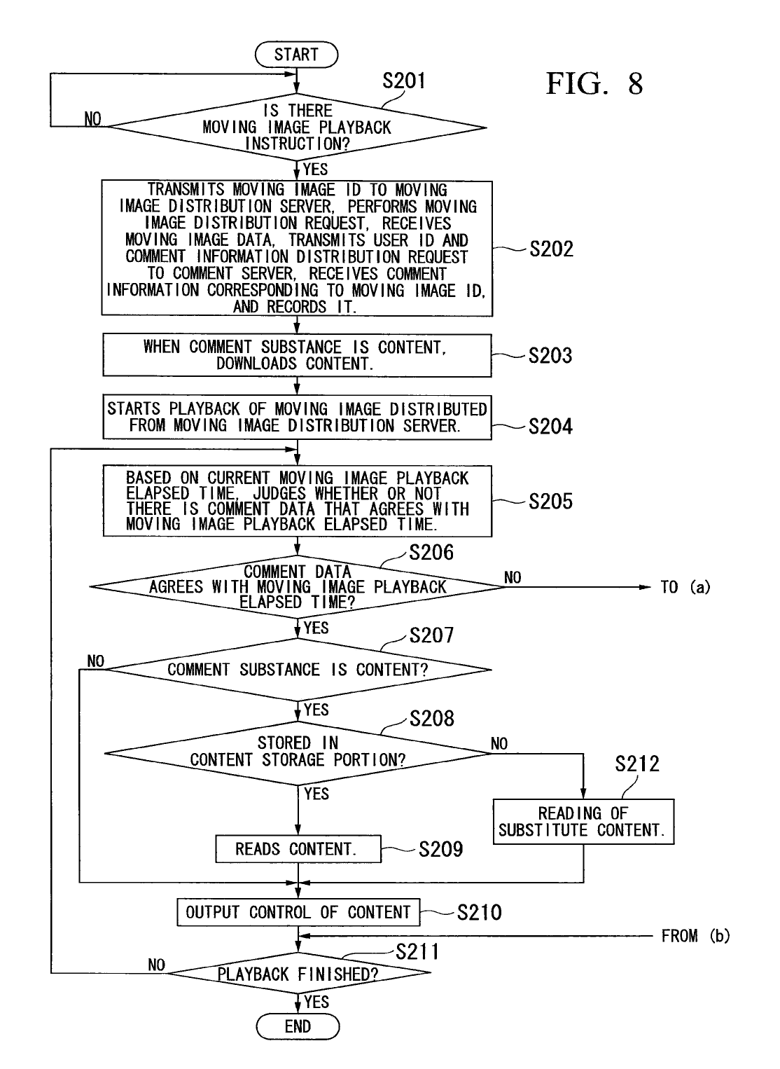

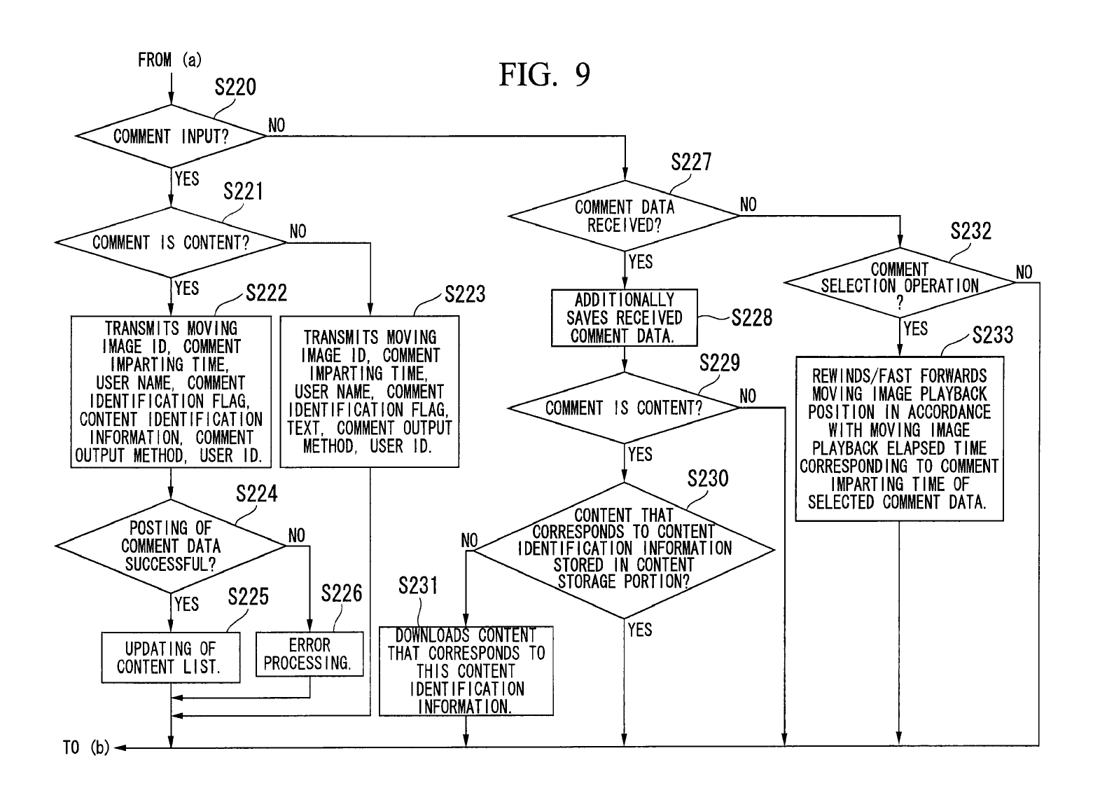

Next, the operation of the terminal device 3 shall be described using drawings. FIG. 8 and FIG. 9 are flowcharts for describing the operation of the terminal device 3.

First, in FIG. 8, when a moving image to be the playback target is selected by the user from the input portion 317 in the menu screen, and moreover an instruction to play the moving image is input (“YES” in Step S201), the moving image playback portion 311 of the terminal device 3, along with transmitting the moving image ID of the instructed moving image to the moving image transmission server 1, performing a moving image distribution request, and receiving the moving image data, transmits the moving image ID, the user ID, and the distribution request of comment information to the comment distribution server 2, receives the comment information corresponding to the moving image ID, and stores it in the comment information storage portion 313 (Step S202). Here, in the case of the comment data of a comment of text being included in the comment information, it receives the comment data, comment imparting time, comment posting actual time, user name, comment identification flag, and comment output information of that text, and in the case of comment data of a content comment being included in the comment information, it receives the comment imparting time, the comment posting actual time, the user name, the content identification information that is stored as comment content of the comment information, the content name, the comment identification flag, and the comment output method. Here, the received comment information can be stored in a manner divided into text comment data and content comment data in accordance with the comment identification flag.

Moreover, in the case of comment data in which the comment substance is content being included in the received comment information, it transmits the content identification information that is included in the comment data concerned to the content distribution server 5 and performs a content distribution request, and downloads the content from the content distribution server 5 (Step S203). As for this download, in the case of multiple contents, the downloading is performed in the order of the earlier comment imparting time, that is, in the case of the moving image having been played back, in the order from the content that is displayed first.

Next, the terminal device 3 starts the playback of the moving image that has been distributed from the moving image distribution server 1 in the case of the download receiving time having exceeded a time decided in advance (for example, 30 seconds) or the download having finished by the time of outputting content in accordance with the comment imparting time (Step S204), and based on the current moving image playback elapsed time, judges whether or not there is comment data that agrees with the moving image playback elapsed time (Step S205). In the case that the comment data agrees with the moving image playback elapsed time (“YES” in Step S206), it refers to the comment identification information and judges whether or not that comment is content (Step S207), and if it is not content (“NO” in Step S207), it judges it as being a text comment, and proceeds to Step S210 to perform output control of the comment. On the other hand, in the case of the comment substance being content (“YES” in Step S207), it judges whether or not that content is stored in the content storage portion 322 (Step S208), and in the case of being stored in the content storage portion 322 (“YES” in Step S208), performs reading of the content from the content storage portion 322 (Step S209). Then, it performs output control of the content that was read out (Step S210).

In Step S208, in the case of the content that corresponds to the content identification information not being stored in the content storage portion 322 (“NO” in Step S208), the reading out of a substitute content is performed (Step S212), and then the process proceeds to Step S210 to perform output control of the substituted content as a comment.

Then, the moving image playback portion 311 judges whether or not the playback of the moving image is finished (Step S211), and if the playback is finished (“YES” in Step S211), that process is finished, and if the playback is not finished (“NO” in Step S211), the process proceeds to Step S205.

In Step S206, the case of there being no comment data that agrees with the moving image playback elapsed time (“NO” in Step S206) shall be described using the flowchart of FIG. 9.

The terminal device 3 judges whether or not a comment has been input (Step S220), and in the case of judging that the input of a comment has been performed (“YES” in Step S220), judges whether or not that comment is content (Step S221). In the case of the comment being text (“NO” in Step S221), it transmits the moving image ID, the comment imparting time, the user name, the comment identification flag, the text, the comment output method, and the user ID to the comment distribution server 2 (Step S223), and the process proceeds to Step S211. In the case of the comment being content (“YES” in Step S221), it transmits the moving image ID, the comment imparting time, the user name, the comment identification flag, the content identification information, the comment output method, and the user ID to the comment distribution server 2 (Step S222), and after receiving a notification that shows reception of the comment data from the comment distribution server 2, based on the substance of that notification, judges whether or not the posting of the comment data has succeeded or not (Step S224), and if the posting is successful (“YES” in Step S224), the content list is updated (Step S225), and in the case of the posting not being successful (“NO” in Step S224), it outputs by the output device 314 an error that shows that the posting of the comment failed, and performs error processing (Step S226). Here, during updating of the content list, in the case that a number of times of making an utterance has been set for content posted as a comment, a process is performed to decrease that possible number of times of utterance by 1. In the case of there not being a limit on the number of utterances, the process proceeds to the next step without performing any particular process in Step S225.

In Step S220, in the case of the input of a comment not being performed (“NO” in Step S220), the receiving portion 312 detects whether or not comment data has been received from the comment distribution server 2 (Step S227). Here, in the case of receiving the comment data (“YES” in Step S227), the receiving portion 312 additionally saves the received comment data to the comment information storage portion 313 (Step S228), and referring to the content identification flag that is contained in the received comment data, judges whether or not the additionally saved comment is content (Step S229), and if not content (“NO” in Step S229), proceeds to Step S211.

In the case of being content (“YES” in Step S229), the terminal device 3 detects whether or not the content that corresponds to the content identification information has been stored in the content storage portion 322 (Step S230), and in the case of being stored in the content storage portion 322 (“YES” in Step S230), proceeds to Step S211, and in the case of not being stored in the content storage portion 322 (“NO” in Step S230), downloads the content that corresponds to this content identification information by the download portion 321 from the content distribution server 5 (Step S231), and proceeds to Step S211. Here, while performing the downloading, it performs the process from Step S211.

In Step S227, in the case of having not received the comment data (“NO” in Step S227), the input portion 317 judges whether or not there was a comment selection operation (Step S232), and if there was not a comment selection operation (“NO” in Step S232), proceeds to step S211, and if there was a comment selection operation (“YES” in Step S232), rewinds or fast forwards the moving image playback position in accordance with the moving image playback elapsed time corresponding to the comment imparting time of the selected comment data (Step S233) and proceeds to Step S211.

By performing such processing, various comments are output by the output device 314 of the terminal device 3 one by one in accordance with the playback elapsed time of the moving image. If this comment is a moving image or still image, text, animation, it is displayed in the display space 105 shown in FIG. 6. For example, in the case of the content serving as the comment being a moving image, as shown by the reference numeral 130 of FIG. 6, the moving image is displayed on the screen. Also, in the case of the content serving as the comment being audio, audio data such as a song or sound effect is output from the audio output device. Here, along with the audio being output, a still image that corresponds to this audio may, as shown by reference numeral 131 in FIG. 6, be displayed in combination on the screen. Also, it is possible to execute an application such as a game as a comment during moving image replay.

In the embodiment explained above, in the case of content being posted as a comment from another user while the moving image is received and being viewed, at that point of time, it judges whether or not it is content that is stored in its own terminal device 3, and is downloaded as needed, but in the case of a content comment whose comment imparting time is set at a time near the time of the playback elapsed time of the moving image that is currently being played approaching being newly uttered from another user, prior to the download of the comment content concerned that was uttered being completed, the playback elapsed time of the moving image may end up passing the comment imparting time that was set in the comment being downloaded. In such a case, it is possible to display a substitute content in Step S212.

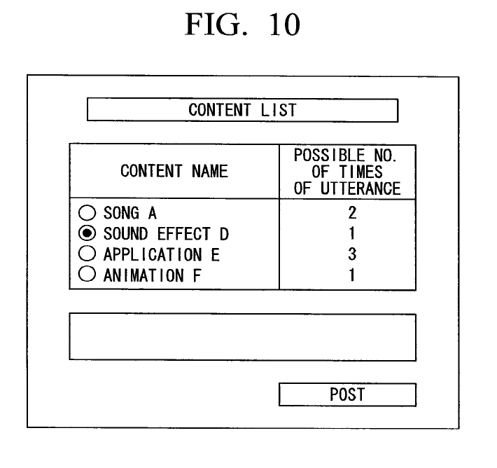

Note that in the aforementioned embodiment, in the display column 120 of FIG. 6, the case was described of the contents that can be uttered being listed one by one, but as shown in FIG. 10, the contents that can be uttered and the number of times they can be uttered may be displayed in a corresponding manner. Here it is possible to select by a radio button, as one example, which content is utilized as a comment. Then, by clicking the “post” button, the moving image playback elapsed time at the point of time that that “post” button has been clicked is set as the comment imparting time, and is transmitted to the comment distribution server 2 as comment data.

Also, in the aforementioned embodiment, the number of postings that can be made decreases by 1 each time a content is posted, and at the point of time at which the possible number of times of utterance reaches “0”, that content become unselectable, but by accessing the content distribution server 5 and newly purchasing content, the possible number of times of utterance is counted up, and posting becomes possible.

Also, in the aforementioned embodiment, in the case of a moving image ID that can be uttered corresponding to content identification information being decided, the authentication portion 24 of the comment distribution server 2 judges, for the content comment that is uttered, whether or not the combination of the comment identification information and the moving image ID matches the combination of the content identification information and the utterance allowable target moving image ID, and in the case of the combinations matching, may receive the comment information. Thereby, it is possible to utter a content as a comment that matches the substance of the moving image, and it becomes possible to also bring out the interest unique to the moving image.

Also, in the aforementioned embodiment, the user that uttered the comment that was uttered may delete it, or a user other than the user who made the utterance may be able to delete it. Here, in accordance with the comment deletion instruction from a user who has the authorization to delete a comment that is input via the terminal device 3, the deletion of the comment can be performed so that it is not displayed on the screen. Also, even in the case of a user not directly having the authorization to delete a comment, in accordance with a number of comment deletion requests from users who do not have that authorization, it is possible to put the comment in a semi-transparent state or cause the comment to not be displayed. Here, the comment distribution server 2 receives this comment deletion instruction, and may delete the comment from the comment information storage portion 27, and the display method of the comment for which the deletion instruction has been input may be set to “hide”, or in accordance with the number of deletion instructions, may be made to be “semi-transparent” or “transparent”. Note that in even the case of the comment being content, in the case of the content being a moving image or animation, similarly to text, it can be set to “hide”, “semi-transparent”, or “transparent” or the like, and in the case of the content being audio, it is possible to reduce the volume thereof.

Thereby, with regard to whether or not it is a comment that unsuited to the moving image, is it is possible to display the comment in consideration of the intent of the moderator of the thread or other users. Also, even for users that do not possess the authorization to be able to delete a comment with just their own will, in accordance with the number of those users, it is possible to delete the comment, or display it in semi-transparent manner or different from other comments. Thereby, among a plurality of users, it is possible to perform writing and deleting of comments, and it is possible to enhance the enjoyment of a thread.

The comment display method was described in the case of “normal”, “semi-transparent”, and “transparent”, but a comment that is targeted for deletion may be displayed in a different manner from ordinary comments, for example, there may be multiple levels of semi-transparency, the color of the comment may be changed, or the character size, character font and color gradation may be changed, or it may be outlined.

Also, it may receive the input of a cancellation request of a comment deletion from a user that has the authorization to delete comments, and in accordance with this instruction, cause a deleted comment to be displayed.

Also, it extracts comment data of a range that goes back a certain period from a some point in time from the comment information that is stored by the comment information storage portion 27 of the comment distribution server 2, and may save it as master comment information. It successively stores the newly registered comment data as normal comment information in the comment information storage portion 27, and in the case of there being a transmission request of comment information from the terminal device 3, may transmit this master comment information and the normal comment information to the terminal device 3. Then, in the terminal device 3, the master comment information is displayed on the screen as a first layer, and the normal comment information may be displayed stacked on this layer. Here, the master comment information may not be possible to delete except by a specified user such as a moderator or the like, while the normal comment information may be possible to delete. Thereby, it is possible to generate an utterance that is left on a past impression, and with respect to that comment, moreover a user can make an utterance.

In the embodiment mentioned above, content that is used for an utterance was described in the case of a user that utters a comment downloading content that is prepared in advance from the content distribution server 5 by the terminal device 3, but the user may create original content and upload it to the content distribution server 5 to post it as a comment.

When doing so, it is preferred that the format of the content that is to be uploaded be of a format decided beforehand.

Note that functions that are different from the functions of the terminal device 3 described above may be installed as plug-ins in a terminal device that has a function to playback moving images so as to realize the functions of the terminal device 3 mentioned above.

Also, in the embodiment described above, distribution of a comment and display control of a comment may be performed by recording on a computer-readable recording medium a program for realizing the functions of the comment distribution server 2 in FIG. 2, or a program for realizing the functions of the terminal device 3 in FIG. 5, reading the program that is recorded on this recording medium into a computer system, and executing it. Also, a program for realizing the functions of the terminal device 3 in FIG. 5 may be made to be applied as a plug-in to an existing terminal device. Note that “computer system” here refers to one that includes an operating system as well as hardware such as peripheral devices.

Additionally, when utilizing a WWW system, the “computer system” also includes a homepage providing environment (or display environment).

Also, a “computer-readable recording medium” refers to a portable medium such as a flexible disk, magneto-optical disk, ROM, CD-ROM and the like, and a storage device such as a hard disk that is housed in a computer system. The “computer-readable storage medium” also includes one for holding the program for a certain time, such as a volatile memory in a computer system which functions as a server or client. Also, the program may be one for realizing a portion of the above-mentioned functions, and it is also possible to realize the abovementioned functions in combination with a program that has already been stored in the computer system.

While preferred embodiments of the invention have been described and illustrated above, specific constitutions are not limited to these embodiments, and designs are also included of a scope that do not depart from the spirit of the present invention.

### INDUSTRIAL APPLICABILITY

According to the present invention, since a user who has the authorization to use a content is able to utter that content as a comment, it is possible to register information other than text as a comment, and thereby a user is able to perform an utterance with information other than text, and so it is possible to further enhance the communication property and the entertainment property. Thereby, it is extremely industrially useful.

1. A terminal device in a comment distribution system that has a moving image distribution server that distributes moving image data, a comment distribution server that distributes comments on a moving image, and a terminal device, comprising:
a list storage portion that stores content that can be uttered as a comment on the moving image data as a list of content identification information that identifies the content;
an input portion that receives a data input of a selection instruction that selects a content to be uttered as a comment from a user on a content that is stored in the list storage portion; and
a transmission portion that receives an input of content identification information of a content that is selected from the list storage portion in accordance with the selection instruction input to the input portion for moving image data that is distributed from the moving image distribution server and transmits a moving image playback elapsed time at the point of time that the content has been uttered as a comment as a comment imparting time together with the content identification information as comment information to the comment distribution server.

2. The terminal device according to claim 1, wherein the content is any one of text, audio, a still image, a moving image, or a program.

3. The terminal device according to claim 1, comprising:
a content storage portion that stores content identification information and content that becomes the substance of the comment in a corresponding manner;
a comment information receiving portion that receives comment information that is distributed from the comment distribution server;
a content reading portion that, among the comment information that the comment information receiving portion has received, reads the content identification information of the comment information in which a comment imparting time that corresponds to the playback elapsed time of the moving image data is set, and reads from the content storage portion the content that corresponds to the content identification information that was read; and
a content output portion that, in accordance with the comment imparting time, outputs the content that the content reading portion has read in accordance with the playback elapsed time of the moving image data.

4. The terminal device according to claim 3, wherein
a content distribution server that distributes a content to become a comment that can be uttered on the moving image data is provided in the comment distribution system; and
the content reading portion, in the case of the content corresponding to the content identification information not being stored in the content storage portion, downloads the content corresponding to the content identification information from the content distribution server.

5. The terminal device according to claim 4, wherein
the output portion, in the case of downloading of the content corresponding to the content identification information not being completed at the playback elapsed time that corresponds to the comment imparting time of the moving image data, outputs a content that is different from the content whose downloading is not completed.

6. The terminal device according to claim 1, wherein
the list storage portion stores a possible number of times of utterance of being possible of uttering a content as a comment, and
each time a content that is stored in the list storage portion is selected by the input portion, decreases the count number of the possible number of times of utterance, and in the case of having a possible number of times of utterance, can be made utterable.

7. The terminal device according to claim 1, wherein
the list storage portion stores a possible period of utterance of being possible of uttering a content as a comment, and
in the case of a content that is stored in the list storage portion being selected by the input portion, in the case of the content being in the possible period of utterance, can be made utterable.

8. A comment distribution server in a comment distribution system that has a moving image distribution server that distributes moving image data, a comment distribution server that distributes comments on a moving image, and a terminal device, comprising:
a user information storage portion that stores content identification information that identifies content that is capable of being uttered as a comment on the moving image in correspondence with user identification information that identifies users;
a receiving portion that receives as comment information content identification information, user identification information, and a comment imparting time that shows the moving image playback elapsed time at the point of time that the content identification information was imparted as a comment, that are transmitted from the terminal device;
an authentication portion that refers to the user information storage portion and detects whether or not the combination of the content identification information and the user identification information that the receiving portion has received has been stored in the user information storage portion;
a comment information storage portion that stores comment information;
a comment information management portion that, based on the authentication result of the authentication portion, in the case of the combination of the content identification information and the user identification information that the receiving portion has received being stored in the user information storage portion, stores the comment information in the comment information storage portion, and in the case of the combination of the content identification information and the user identification information that the receiving portion has received not being stored in the user information storage portion, does not store the comment information in the comment information storage portion, and
a comment information distribution portion that distributes comment information that is stored in the comment information storage portion to the terminal device.

9. The comment distribution server according to claim 8, wherein
the receiving portion receives comment information from the terminal device according to a terminal device in a comment distribution system that has a moving image distribution server that distributes moving image data, a comment distribution server that distributes comments on a moving image, and a terminal device, comprising:
a list storage portion that stores content that can be uttered as a comment on the moving image data as a list of content identification information that identifies the content;
an input portion that receives a data input of a selection instruction that selects a content to be uttered as a comment from a user on a content that is stored in the list storage portion; and
a transmission portion that receives an input of content identification information of a content that is selected from the list storage portion in accordance with the selection instruction input to the input portion for moving image data that is distributed from the moving image distribution server and transmits a moving image playback elapsed time at the point of time that the content has been uttered as a comment as a comment imparting time together with the content identification information as comment information to the comment distribution server.

10. A comment transmission method of a terminal device in a comment distribution system that has a moving image distribution server that distributes moving image data, a comment distribution server that distributes comments on a moving image, and a terminal device, including the steps of:
receiving data input of a selection instruction that selects a content to be uttered as a comment from a user on a content that is stored in a list storage portion that stores content that can be uttered as a comment on the moving image as a list of content identification information that identifies the content concerned; and
receiving an input of content identification information of a content that has been selected from the list storage portion in accordance with the selection instruction that is data input on moving image data that is distributed from the moving image distribution server, and transmitting to the comment distribution server the moving image playback elapsed time at the point in time of the content being uttered as a comment as a comment imparting time along with the content identification information as comment information.

11. A comment distribution method in a comment distribution server in a comment distribution system that has a moving image distribution server that distributes moving image data, a comment distribution server that distributes comments on a moving image, and a terminal device, including the steps of:
receiving as comment information content identification information, user identification information, and a comment imparting time that shows the moving image playback elapsed time at the point of time that the content identification information was imparted as a comment, that are transmitted from the terminal device;
referring to a user information storage portion that stores content identification information that identifies content that is capable of being uttered as a comment on the moving image data in correspondence with the user identification information that identifies users, and detecting whether or not the combination of the content identification information and the user identification information that have been received has been stored in the user information storage portion,
based on the authentication result of the authentication portion, in the case of the combination of the content identification information and the user identification information that have been received being stored in the user information storage portion, storing the comment information in a comment information storage portion that stores comment information, and in the case of the combination of the content identification information and the user identification information that have been received not being stored in the user information storage portion, not storing the comment information in the comment information storage portion, and
distributing the comment information that has been stored in the comment information storage portion to the terminal device.

12. A computer-readable recording medium that houses a program that, in a computer of a terminal device in a comment distribution system that has a moving image distribution server that distributes moving image data, a comment distribution server that distributes comments on a moving image, and a terminal device, performs
a function that receives data input of a selection instruction that selects a content to be uttered as a comment from a user on a content that is stored in the list storage portion that stores content that can be uttered as a comment on the moving image data as a list of content identification information that identifies the content; and
a function that receives an input of content identification information of a content that has been selected from the list storage portion in accordance with the selection instruction that is data input on moving image data that is distributed from the moving image distribution server, and transmits to the comment distribution server the moving image playback elapsed time at the point in time of the content being uttered as a comment as a comment imparting time along with content identification information as comment information.

13. A computer-readable recording medium that houses a program that, in a computer of a terminal device in a comment distribution system that has a moving image distribution server that distributes moving image data, a comment distribution server that distributes comments on a moving image, and a terminal device, performs
a function that that receives as comment information content identification information, user identification information, and a comment imparting time that shows the moving image playback elapsed time at the point of time that the content identification information was imparted as a comment, that are transmitted from the terminal device;
a function that refers to a user information storage portion that stores content identification information that identifies content that is capable of being uttered as a comment on the moving image data in correspondence with user identification information that identifies users, and detects whether or not the combination of the content identification information and the user identification information that have been received has been stored in the user information storage portion; and
a function that, based on the detection result, in the case of the combination of the content identification information and the user identification information that have been received being stored in the user information storage portion, stores the comment information in the comment information storage portion, and in the case of the combination of the content identification information and the user identification information that have been received not being stored in the user information storage portion, does not store the comment information in the comment information storage portion.
